(19) United States
(12) Patent Application Publication
(10) Pub. No.: US 2009/0267762 A1
(43) Pub. Date: Oct. 29, 2009

(54) SYSTEMS AND METHODS FOR DETECTING LOSS OF AN ELECTRONIC DEVICE

(75) Inventors: HER-CHING SHYU, Tu-Cheng (TW); YUN-LONG SIE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/324,854

(22) Filed: Nov. 27, 2008

(30) Foreign Application Priority Data
Apr. 24, 2008 (CN) 200810301279.1

(51) Int. Cl. G08B 21/00

(52) U.S. Cl. 340/540

(57) ABSTRACT

A computing system and method for detecting loss of an electronic device stores an alert time and a recipient for receiving transmittable information, determines whether the electronic device is missing via a collision sensor and a orientation sensor, issues an alert that the electronic device is missing, and sends the transmittable information to the recipient if the retrieval of the electronic device not confirmed within the alert time.

### BACKGROUND

1. Field of the Invention

Embodiments of the disclosure are related to device detection, and particularly to a system and method for detecting loss of an electronic device.

2. Description of Related Art

Portable digital electronic devices in everyday use provide convenience in the fields of communication, entertainment, and data exchange. The portable digital electronic devices may be personal digital assistants, Global Positioning System (GPS) consoles, digital cameras, or mobile phones.

Currently, portable digital electronic devices have an increasing number of functions. Such portable digital electronic devices may store a large amount of personal data or confidential information. The personal data and the confidential information stored in the portable digital electronic devices may be stored as records, phonebook entries, encrypted files, photos, audio recordings, electronic mails (E-mails), or authentication data. If the portable digital electronic device is stolen or lost, the personal data and the confidential information may be accessed or retrieved by any other person, causing the owner great inconvenience.

What is needed, therefore, is a system and method for detecting loss of an electronic device and prompting action accordingly.

### BRIEF DESCRIPTION OF THE DRAWINGS

FIG. 1 is a block diagram of an embodiment of a system for detecting loss of an electronic device.

FIG. 2 is a flowchart of an embodiment of a method for detecting loss of an electronic device.

### DETAILED DESCRIPTION OF CERTAIN INVENTIVE EMBODIMENTS

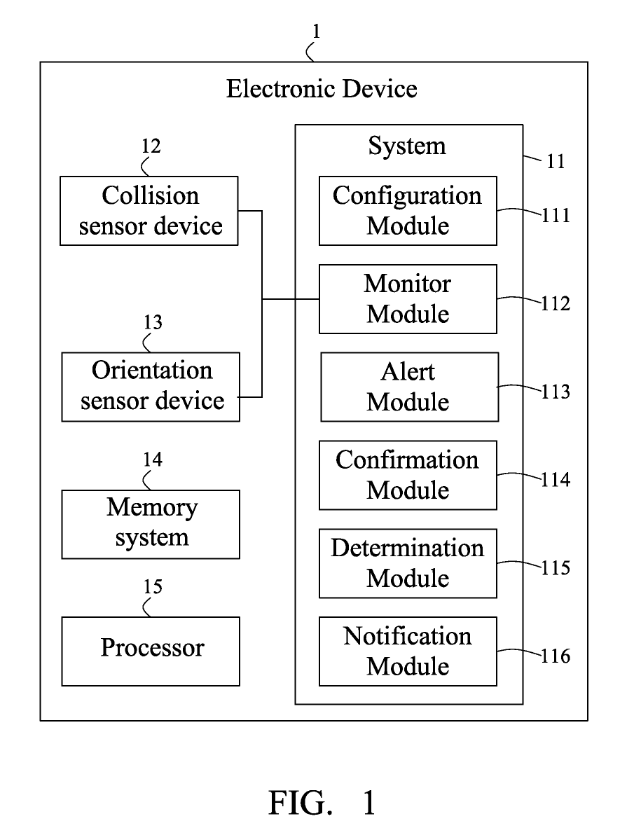

All of the processes described may be embodied in, and fully automated via, software code modules executed by one or more general purpose computers or processors as depicted in FIG. 1. The code modules may be stored in any type of computer-readable medium or other storage device. Some or all of the methods may alternatively be embodied in specialized computer hardware or communication apparatus.

FIG. 1 is a block diagram of an embodiment of a system 11 for detecting loss of an electronic device 1. The electronic device 1 includes the system 11, a collision sensor device 12, a orientation sensor device 13, a memory system 14, and a processor 15. The system 11 may be embodied in the electronic device 1. The memory system 14 may be a hard disk drive, a flash drive, or any other memory storage system. The collision sensor device 12 is configured for determining if the electronic device 1 collides against other objects or surfaces, such as the floor as an example. The orientation sensor device 13 is configured for determining if the electronic device 1 is at a horizontal orientation relative to an axis system (hereinafter, “the horizontal orientation”), such as the floor or ground for example. A typical scenario considered in the system design anticipates the electronic device 1 falling, first colliding against the floor after experiencing acceleration due to gravity, and remaining on the floor at a horizontal orientation. According to the acquired output from the collision sensor 12 and the orientation sensor device 13 accordingly, the disclosed system detects loss of electronic device 1 by, in turn, detection of the device colliding against the ground and staying at the horizontal orientation for at least a predetermined amount of time. It may be understood that the horizontal orientation comprises a preset acceleration threshold, for example, 5°, such that the orientation sensor device 13 thus may conclude the electronic device 1 remains at the horizontal orientation.

In an embodiment, the system 11 further includes a configuration module 111, a monitor module 112, an alert module 113, a confirmation module 114, a determination module 115, and a notification module 116. The modules 111, 112, 113, 114, 115, and 116 execute one or more operations for the system 11. Additionally, the electronic device 1 may comprise one or more specialized or general purpose processors, such as a processor 15 executing one or more operations for the modules 111, 112, 113, 114, 115, and 116.

The configuration module 111 is configured for enabling entry of an alert time of retrieval of the electronic device 1 from the ground and entry of a notification recipient identification to receive transmittable information. The alert time of the retrieval of the electronic device 1 is a duration of time allowed for a user of the electronic device 1 to retrieve the electronic device 1 determined to have fallen. As an example, the alert time of the retrieval of the electronic device 1 may be set as, but is not limited to, 1, 2, 3, or 5 minutes. Furthermore, the configuration module 111 registers data of a user's input, including the alert time of the retrieval of the electronic device 1 and data regarding the notification recipient identification. Here, data regarding the time of the retrieval of the electronic device 1 and data regarding the notification recipient identification is stored in the memory system 14. As will be further explained below, the notification recipient identification may include, but is not limited to an E-mail address of the user, a Short Message Service (SMS) message or a Multimedia Message Service (MMS) message.

The configuration module 111 is also configured for setting a notification mode and storing the notification mode in the memory system 14. The notification mode may be activated to signal an alert to a user that the electronic device 1 is missing. In this embodiment, notification modes may include, but are not limited to, emitting audible alert, vibration, visible alert, and/or a combination of the three of the electronic device 1.

The transmittable information includes personal information stored in the electronic device 1 such as call records, phonebook entries, personal short messages, personal electronic mails (E-mails), encrypted files, photos, audio recordings, and authentication data. In this embodiment, the transmittable information is stored in the memory system 14. Alternatively, in other embodiments, the personal information may also include information such as location of the transmitting device, acquired by Global Positioning System (GPS) if the electronic device 1 supports such a system.

The notification recipient identification, in this embodiment, may include, but is not limited to, E-mail addresses and mobile phone numbers.

The monitor module 112 is configured for determining if the electronic device 1 falls and collides against the ground via the collision sensor device 12. In this embodiment, the collision sensor device 12 determines if the electronic device 1 falls and collides against other objects through a change in acceleration. Additionally, if the collision sensor device 12 detects an instantaneous acceleration of the electronic device 1 exceeding a preset acceleration threshold, for example, 8 meters/second*second (m/s²), and detects a counter-direction deceleration due to colliding against other objects or surfaces afterwards, the collision sensor device 12 thus may conclude the falling and collision of the electronic device 1. In one embodiment, the collision sensor device 12 may be an accelerometer.

The monitor module 112 is also configured for determining if the electronic device 1 remains at a horizontal orientation via the orientation sensor device 13 after the determination of the falling and collision of the electronic device 1 is made. In this embodiment, the orientation sensor device 13 determines if the electronic device 1 remains at the horizontal orientation through an inclined angle relative to the ground. For example, if the orientation sensor device 13 detects the inclined angle relative to the ground of the electronic device 1 is less than a preset acceleration threshold, the orientation sensor device 13 may conclude the electronic device 1 remains at the horizontal orientation. As mentioned above, the preset acceleration threshold may be 5°, for example.

The alert module 113 is configured for activating a preset notification mode to alert a user that the electronic device 1 is missing if the monitor module 112 determines the electronic device 1 remains at the horizontal orientation. Furthermore, the alert module 113 is also configured for reminding the user to retrieve the electronic device 1. As mentioned previously, notification modes may include, but are not limited to, emitting an audible alert, a vibration, a visible alert, and/or a combination of the three of the electronic device 1. Setting the notification mode may be predetermined by a user of the electronic device 1. For example, the alert module 113 may direct the electronic device 1 to emit an amplified audible alarm so as to ensure the user hears the alarm within an alarm range. The alarm ranges may be set as, but are not limited to, 5 meters. The user may take appropriate actions, for example, pick up the missing the electronic device 1 from the ground in response to the alarm from the electronic device 1.

The confirmation module 114 is configured for providing a confirmation interface for enabling entry of a retrieval confirmation from the user after the retrieval of the electronic device 1.

The determination module 115 is configured for determining if the user makes the retrieval confirmation via the confirmation interface within the alert time of the retrieval.

The notification module 116 is configured for sending a notification of the transmittable information to the notification recipient if the user does not make the confirmation via the confirmation interface within the alert time of the retrieval. As an example, if the notification recipient identification is configured as an E-mail address, the notification module 16 sends the transmittable information from the electronic device 1 to the E-mail address in form of E-mail messages. As another example, if the notification recipient identification is configured as a mobile phone number, the notification module 116 sends the transmittable information to the mobile phone accordingly in form of Short Message Service (SMS) messages or Multimedia Message Service (MMS) messages. An example of the method follows.

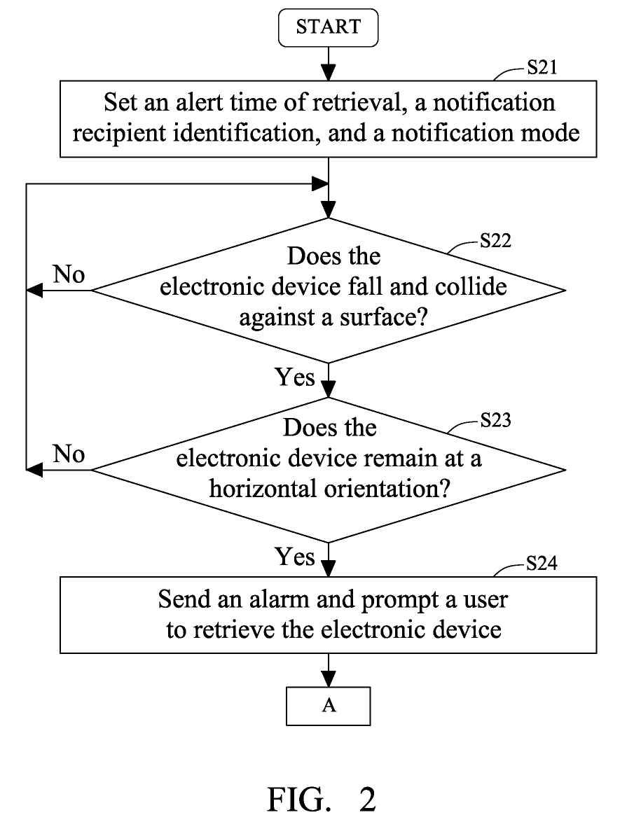

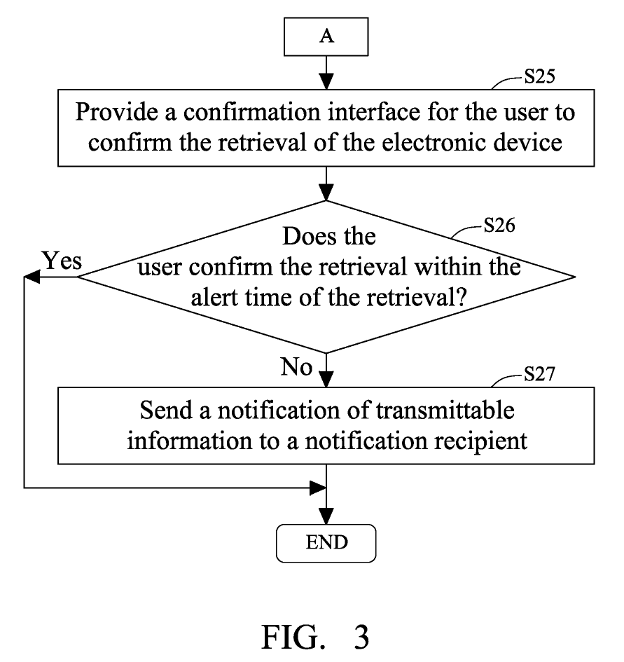

FIG. 2 is a flowchart of an embodiment of a method for detecting loss of an electronic device 1. Depending on the embodiment, additional blocks may be added or deleted and the blocks executed in different orders than as described. First, in block S21, the configuration module 111 registers the data of a user's input, including an alert time of the retrieval of the electronic device 1, a notification recipient identification for transmittable information, and a notification mode for alerting the user that the electronic device 1 is missing.

In block S22, the monitor module 112 determines if the electronic device 1 falls and collides against the surfaces via the collision sensor device 12.

In block S23, the monitor module 112 determines if the electronic device 1 remains at the horizontal orientation via the orientation sensor device 13.

In block S24, the alert module 113 activates the preset notification mode to alert the user that the electronic device 1 remains on the ground and prompt the user to retrieve the electronic device 1.

In block S25, the confirmation module 114 provides the confirmation interface enabling the entry of the confirmation from the user after the retrieval of the electronic device 1.

In block S26, the determination module 115 determines confirmation via the confirmation interface within the alert time of the retrieval.

In block S27, if no confirmation is input via the confirmation interface within the alert time of the retrieval, the notification module 116 sends notification of the transmittable information to the notification recipient. The process is completed.

In block S22, if the monitor module 112 determines the electronic device 1 does not fall and not collide with any object, block S22 is repeated to continue monitoring the electronic device 1.

In block S23, if the monitor module 112 determines the electronic device 1 does not remain at the horizontal orientation, the block S22 is repeated to continue monitoring the electronic device 1.

In block S26, if confirmation is input via the confirmation interface within the alert time of the retrieval, the process is complete.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A system for detecting loss of an electronic device, the electronic device comprising a collision sensor and an orientation sensor, the system comprising:
a monitor module configured for determining if the electronic device falls and collides against a surface via the collision sensor, and determining if the electronic device remains at a horizontal orientation relative to the surface via the orientation sensor for at least a predetermined amount of time;
a configuration module configured for receiving setting of a notification mode indicative of the electronic device falling and colliding against the surface, wherein the notification mode is user selectable; and
an alert module configured for activating the notification mode to signal an alert that the electronic device is missing in response to the monitor module determining that the electronic device remains at a horizontal orientation relative to the surface for the at least predetermined amount of time.

2. The system as claimed in claim 1, the confirmation module further comprising,
enabling entry of an alert time of retrieval of the electronic device, entry of a notification recipient identification for receiving transmittable information, and entry of confirmation that the electronic device has been retrieved by a user.

3. The system as claimed in claim 1, the determination module further comprising,
determining if a confirmation via the confirmation interface is made within the alert time of the retrieval of the electronic device.

4. The system as claimed in claim 2, the notification module further comprising,
sending a notification of the transmittable information to the notification recipient if the confirmation via the confirmation interface is not made within the alert time of the retrieval of the electronic device.

5. The system as claimed in claim 2, wherein the transmittable information comprises personal information stored in the electronic device.

6. The system as claimed in claim 2, wherein the notification recipient identifications comprise at least an electronic mail address or a mobile phone number.

7. The system as claimed in claim 1, wherein the monitor module determines if the electronic device falls and collides against the surface by detecting an instantaneous acceleration of the electronic device, determining if the instantaneous acceleration exceeds a preset acceleration threshold, and detecting a counter-direction deceleration of the electronic device.

8. The system as claimed in claim 1, wherein the monitor module determines if the electronic device remains at the horizontal orientation relative to the surface through an inclined angle relative to the surface for the at least predetermined amount of time.

9. A computer-implemented method for detecting loss of an electronic device, the electronic device comprising a collision sensor and an orientation sensor, the method comprising:
registering a notification mode indicative of the electronic device falling and colliding against a surface, wherein the notification mode is user selectable;
determining if the electronic device falls and collides against a surface via the collision sensor, and determining if the electronic device remains in a horizontal orientation relative to the surface via the orientation sensor for at least a predetermined amount of time; and
activating the notification mode to signal an alert that the electronic device is missing in response to the monitor module determining that the electronic device remains at a horizontal orientation relative to the surface for the at least predetermined amount of time.

10. The method as claimed in claim 9, wherein the method further comprises registering an alert time of retrieval of the electronic device and a notification recipient identification for receiving transmittable information.

11. The method as claimed in claim 9, the method further comprises:
registering a confirmation after retrieval of the electronic device;
determining if the confirmation is made within the alert time of the retrieval of the electronic device; and
sending a notification of the transmittable information to the notification recipient if the confirmation via the confirmation interface is not made within the alert time of the retrieval of the electronic device.

12. The method as claimed in claim 10, wherein the notification recipient identifications comprise at least an electronic mail address and a mobile phone number.

13. The method as claimed in claim 9, wherein the determination of the electronic device falling and colliding against the surface is made through a change in acceleration.

14. The method as claimed in claim 9, wherein the determination of the electronic device remaining at the horizontal orientation is according to an inclined angle relative to the surface for the at least predetermined amount of time.

15. The method as claimed in claim 9, wherein the determination of the electronic device falling and colliding against the surface is according to detecting an instantaneous acceleration of the electronic device, determining if the instantaneous acceleration exceeds a preset acceleration threshold, and detecting a counter-direction deceleration of the electronic device.

16. A computer-readable medium having stored thereon instructions that, when executed by a computer, cause the computer to perform a method for detecting loss of an electronic device, the electronic device comprising a collision sensor device and an orientation sensor device, the method comprising:
registering a notification mode indicative of the electronic device falling and colliding against a surface, wherein the notification mode is user selectable;
determining if the electronic device falls and collides against a surface via the collision sensor, and determining if the electronic device remains in a horizontal orientation relative to the surface via the orientation sensor for at least a predetermined amount of time; and
activating the notification mode to signal an alert that the electronic device is missing in response to the monitor module determining that the electronic device remains at a horizontal orientation relative to the surface for the at least predetermined amount of time.

17. The computer-readable medium as claimed in claim 16, the method further comprising:
registering a confirmation after retrieval of the electronic device;
determining if the confirmation is made within the alert time of the retrieval of the electronic device; and
sending a notification of the transmittable information to the notification recipient if the confirmation via the confirmation interface is not made within the alert time of the retrieval of the electronic device.

18. The computer-readable medium as claimed in claim 17, wherein the notification recipient identifications comprise at least an electronic mail addresses and a mobile phone number.

19. The computer-readable medium as claimed in claim 16, wherein the determination of the electronic device remaining at the horizontal orientation is according to an inclined angle relative to the surface for the at least predetermined amount of time.

20. The computer-readable medium as claimed in claim 16, wherein the determination of the electronic device falling and colliding against the surface is according to detecting an instantaneous acceleration of the electronic device, determining if the instantaneous acceleration exceeds a preset acceleration threshold, and detecting a counter-direction deceleration of the electronic device.
